(19) United States
(12) Patent Application Publication
(10) Pub. No.: US 2004/0087370 A1
(43) Pub. Date: May 6, 2004

(54) Gaming system

(76) Inventor: Elia Rocco Tarantino, Las Vegas, NV (US)

Correspondence Address: WEIDE & MILLER, LTD., 7251 W. LAKE MEAD BLVD., SUITE 530, LAS VEGAS, NV, 89128, US

(21) Appl. No.: 10/691,774

(22) Filed: Oct. 22, 2003

Related U.S. Application Data
(63) Continuation-in-part of application No. 10/636,828, filed on Aug. 6, 2003.
Application No. 10/636,828 is a continuation-in-part of application No. 09/553,915, filed on Apr. 20, 2000, now Pat. No. 6,605,001.
Application No. 09/553,915 is a continuation-in-part of application No. 09/439,934, filed on Nov. 12, 1999, now Pat. No. 6,656,047.
Application No. 09/439,934 is a continuation-in-part of application No. 09/298,604, filed on Apr. 23, 1999, now abandoned.
(63) Continuation-in-part of application No. 10/143,367, filed on May 9, 2002.
Application No. 10/143,367 is a continuation-in-part of application No. 10/004,102, filed on Oct. 23, 2001, now Pat. No. 6,702,671.

(51) Int. Cl. G06F 17/00; G06F 19/00

(52) U.S. Cl. 463/42

(57) ABSTRACT

Gaming systems are configured to present wagering-type games to players. In one embodiment, players use portable devices such as cellular phones to play a game in which they receive a score. Players with winning scores are awarded winnings from a jackpot which is funded from charges associated with air time. In another embodiment, games are presented on gaming machines which may be located in one territory and which are associated with a gaming server located in another territory. Communication occurs via transmitter/receivers located in each territory and a communication link extending there between and through one or more satellites.

### CROSS REFERENCE TO RELATED APPLICATIONS

This application is a continuation-in-part of U.S. application Ser. No. 10/636,828 filed on Aug. 6, 2003, which is a continuation-in-part of U.S. application Ser. No. 09/553,915, filed on Apr. 20, 2000, which is a continuation-in-part of U.S. application Ser. No. 09/439,934, filed on Nov. 12, 1999, which is a continuation-in-part of U.S. application Ser. No. 09/298,604 filed on Apr. 23, 1999, and this application is a continuation-in-part of U.S. application Ser. No. 10/143,367 filed on May 9, 2002, which is a continuation-in-part of U.S. application Ser. No. 10/004,102 filed on Apr. 19, 2001.

### FIELD OF THE INVENTION

The present invention relates generally to methods and devices for playing games, and in particular to methods and systems for playing dice games.

### BACKGROUND OF THE INVENTION

Traditionally, wagering type games have been presented at tables or stand-alone gaming machines. In recent years, electronically-controlled gaming machines have been associated with gaming networks. These networks are generally hard-wired networks which link a plurality of gaming machines with one or more servers. The servers may be used, for example, to track game play at the gaming machines, including the amounts of wagers placed and winnings paid.

These systems have a number of drawbacks. One drawback is that the system does not permit players to play games from a remote location. Another drawback is that these networks are often cumbersome and complicated and not readily suited to use with gaming machines which are located remotely from one another, as compared to when they are located next to one another in a casino.

### SUMMARY OF THE INVENTION

The present invention provides apparatus and methods for presenting and playing various games. The games of the invention are preferably implemented via one or more gaming devices.

In one embodiment, the gaming devices comprise computer-controlled slot machines. For multiple player games, the machines are interlinked onto a local or wide-area network.

In another embodiment of the invention, games are presented on other devices, such as personal data assistants (PDAs), cellular phones, personal computers or the like. Preferably, players provide monetary value in order to play the games, and monetary winnings are paid for winning results or outcomes. In one embodiment, a player provides a direct bet or wager in order to play a game. In another embodiment, the monetary value may be associated with or comprise air time (such as in the case of a cellular phone) or play time, including access time.

In one embodiment, the games are presented using game program code. A player obtains a media including the game program code such as by purchasing it. The player loads the program code onto the game device, such as a cell phone or PDA, from the media.

In one or more games, a player plays a game for a score. The player's score may determine if they are entitled to a winning payout. The games may also be played as a multi-player game. In one embodiment, players play for scores, which scores may be stored and checked, permitting a player to determine their “standing” in the game. In one embodiment, a player may check their score by accessing a website. In one embodiment, the player or players having the highest score or scores are eligible to participate in the jackpot. If upon checking the player learns that their score is not among the highest scores, they may play the game again in an attempt to achieve a higher score.

In accordance with one embodiment of a gaming system, game data is preferably transmitted from one territory to another via communication link extending from the first territory to the second territory via one or more satellites. In one embodiment, a game server may be located in the first territory and gaming machines located in the second territory may be linked to the game server via the communication link. The satellite-routed communication link avoids the use of devices and links in other territories other than the first and second territories.

Further objects, features, and advantages of the present invention over the prior art will become apparent from the detailed description of the drawings which follows, when considered with the attached figures.

### DESCRIPTION OF THE DRAWINGS

FIG. 1 is a perspective view of a computer-controlled slot machine, in accordance with one embodiment of the gaming system of the present invention.

FIG. 2 is a perspective view of four computer-controlled slot machines assembled in a bar table according to another embodiment of the present invention for single or simultaneous multiple user play.

FIG. 3 is a block diagram of a local area network of computer-controlled slot machines, according to the present invention for progressive gaming activity.

FIG. 4 is a block diagram of a wide area network of computer-controlled slot machines, according to the present invention for progressive gaming activity.

FIG. 5A is a diagram of a touch-sensitive display of a computer-controlled slot machine, in accordance with one embodiment of the gaming system of the present invention.

FIG. 5B is a diagram of a touch-sensitive display of a computer-controlled slot machine, in accordance with an alternative embodiment of the gaming system of the present invention.

FIG. 6 is a block diagram of the microprocessor-controlled computer and the computer program which facilitate game play according to one embodiment of the present invention.

FIG. 7 is a flow chart illustrating one embodiment of a game of the invention.

FIG. 8 is a flow chart illustrating another embodiment of a game of the invention.

FIG. 9 illustrates another environment for play of games in accordance with the present invention.

FIG. 10 is a flowchart illustrating yet another embodiment game of the present invention.

FIG. 11 illustrates a game network in accordance with another embodiment of the invention.

### DETAILED DESCRIPTION OF THE INVENTION

The invention comprises methods and apparatus for presenting and playing a game. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention

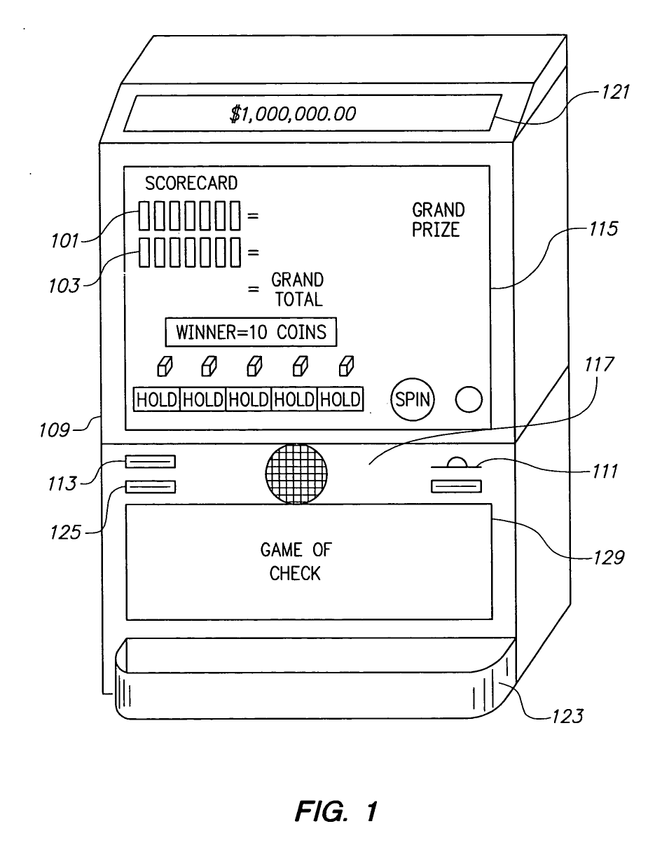

In one or more embodiments, games may be presented for play on a computer-controlled slot machine, for example as shown in FIG. 1. The computer-controlled slot machine 101 includes a microprocessor-controlled computer 103 within a tamper proof and lockable cabinet 109 having a coin acceptor 111 for wagers and a bill validator 113 for wagers, and preferably including a touch-sensitive display 115 for player input and game display. In addition, the computer-controlled slot machine includes a sound speaker 117 for output of digital sound and voice simulations, a tower light 119 (not shown) to indicate jackpots and other game statistics, and a meter 121 to display progressive jackpot information and other text. The computer 103 controls release of coins to a coin hopper 123 for paying players, and controls a ticket printer 125 for generating vouchers. The computer 103 also controls a machine-readable medium reading and writing device 129 for saving and restoring games in progress.

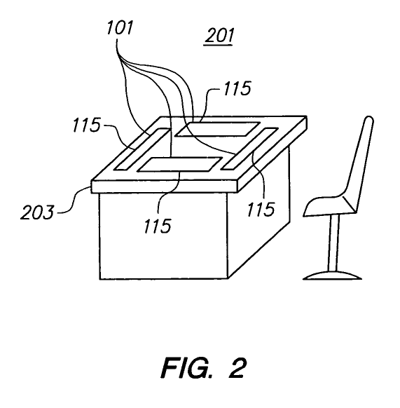

An alternative embodiment of the computer-controlled slot machine is illustrated in FIG. 2. A “bar buddy” version of a computer-controlled slot machine 201 includes all of the features of the computer-controlled slot machine 101. Each “bar buddy” computer-controlled slot machine 201 contains four such computer-controlled slot machines 101, assembled within a bar table 203. Each of the four touch-sensitive displays 115 for player input and game display are mounted in the surface of the bar table 203. The bar buddy computer-controlled slot machine 201 enables from one to four players to play games of the invention simultaneously, either against each other or against the house. The various modes of game play are detailed below.

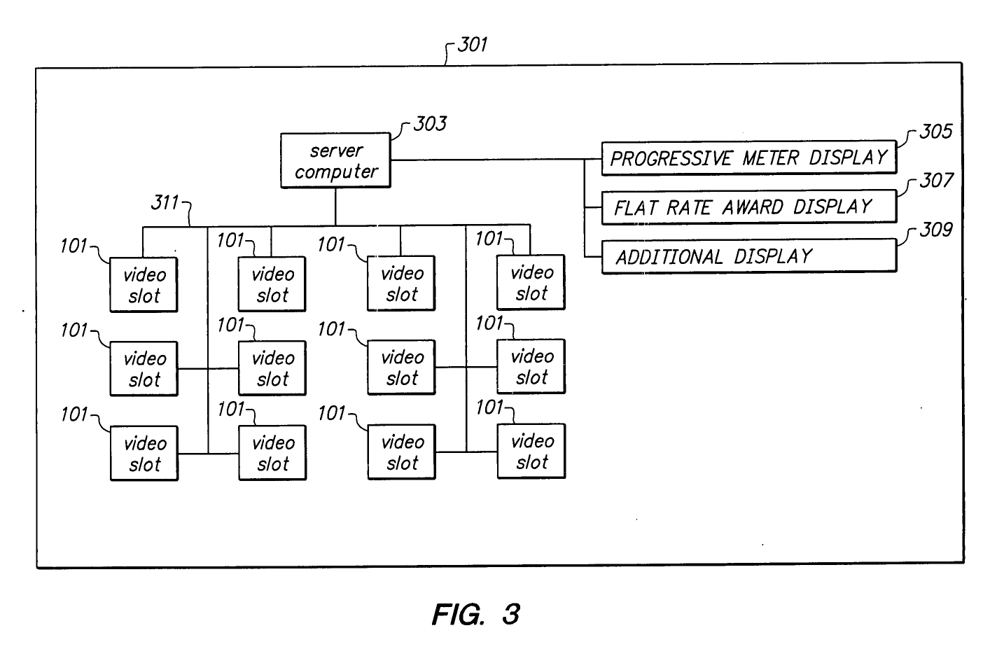

Each computer-controlled slot machine 101 is preferably connected to a local area computer network as illustrated in FIG. 3. The local area computer network 301 is controlled by a microprocessor-controlled server computer 303 which controls game play, records game statistics, accounts for vouchers and jackpots, and links the games together. The local area computer network 301 also preferably includes a progressive meter display 305 for showing progressive jackpot information, a flat rate award display 307 for showing flat rate jackpot information, and an additional display 309 for showing the scores that presently qualify for jackpots on the local area network 301. In the preferred embodiment of the present invention, all of the computer-controlled slot machines 101 are connected to the local area computer network 301 in conventional manner via private dedicated lines 311. In an alternative embodiment, some or all of the computer-controlled slot machines 101 positioned at remote locations are connected to the local area computer network 301 via modems and public telephone lines operated in secure mode through encryption/decryption techniques.

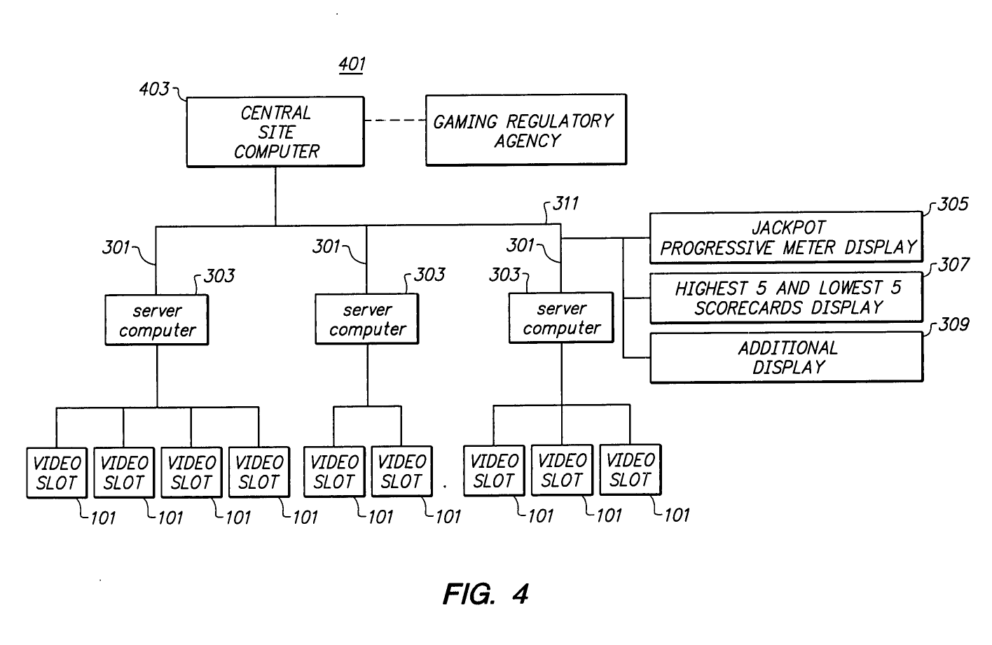

Each local area network 301 of computer-controlled slot machines 101 may be connected to a wide area computer network as illustrated in FIG. 4. The wide area computer network 401 includes local area computer networks 301 at various physical locations. The wide area computer network 401 is controlled by a central-site computer 403 which operates in 24-hour-a-day communication with all local area computer networks 301 on the wide area computer network 401 for security, accounting, and verification of games and jackpots. If a local area computer network 301 is connected to a wide area computer network 401, the progressive meter display 305, the flat rate award display 307, and the additional display 309 of that local area computer network 301 all display jackpot and other information pertaining to the entire wide area network 401. For example, the additional display 309 of a local area computer network 301 which is connected to a wide area computer network 401 shows scores that presently qualify for jackpots on the wide area network 401. In the preferred embodiment of the present invention, each local area computer network 301 is connected to the wide area computer network 401 in conventional secured cryptographic manner via private dedicated lines 311. In an alternative embodiment, some or all of the local area computer networks 301 are connected to the wide area computer network 401 in secured cryptographic manner via modems and public telephone lines.

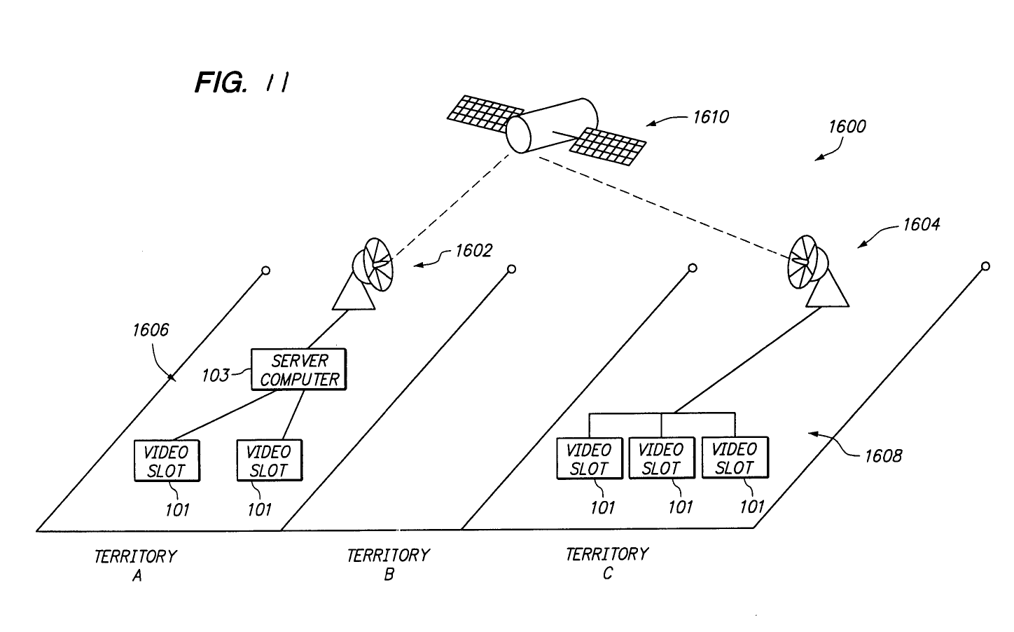

In one embodiment the games of the invention may be presented on gaming devices which are linked by a satellite communication link. FIG. 11 illustrates one such configuration. As illustrated, a first local area computer network 1606 is connected to a second local area computer 1608 network via a satellite communication link 1600 which includes a transmitter/receiver 1602 at the location of the first network and a transmitter/receiver 1604 at the location of the second network. Data is transmitted from one location to the other via one or more satellites 1610, which satellites are preferably located in space and not in any particular territory.

This communication network is particularly suited to an arrangement where one local area computer network is located in a first sovereign territory (such as an Indian land) and the second local area computer network is located in a second sovereign territory. In this communication network, the transmission of data can be completed between the first and second sovereign territories without the communication needing to pass through (including by using one or more communication devices in) a third or other sovereign territory(ies). This may avoid the necessity of compliance with rules and regulations of the third or additional sovereign territory, simplifying the implementation of the game.

This communication arrangement using satellite links may be applied to games or gaming networks other than that described herein and other than those used to implement the one or more games described herein. For example, in one embodiment, the central site or main computer 403 or other host may be located in one of the sovereign territories, and gaming machines 101 in the other sovereign territory may be linked via the satellite communication link 1600, such as by a transmitter/receiver associated with a server computer in that territory. As illustrated, a plurality of gaming machines 101 may also be associated with the main computer 403 in the first territory.

The principal of the method of distributing game information may be applied to multiple territories. For example, a main computer 403 may be configured to transmit game information to gaming machines 101 located in a plurality of other territories.

A variety of game information may be transmitted via the satellite communication link 1600. For example, the game information may comprise actual data for generating game graphics, player tracking data (such as player identification, player wager, player loss and player win data), progressive meter data (such as a progressive win amount for posting at each gaming machine), actual game code (which is executed at/by the gaming machine to present a game) and other information. As indicated, some information may be transmitted from the main computer 403 to the gaming machines 101. Information may also be transmitted from the gaming machines 101 to the main computer 403.

In one embodiment, one or more of the components of each local network 1606, 1608 may communicate using wireless communication links. For example, information may be transmitted from the transmitter/receiver 1602 to the gaming machines 101 using a wireless communication link.

The game information may be disseminated or distributed to other devices and machines within a particular territory using wired or wireless communication links, or other satellite links.

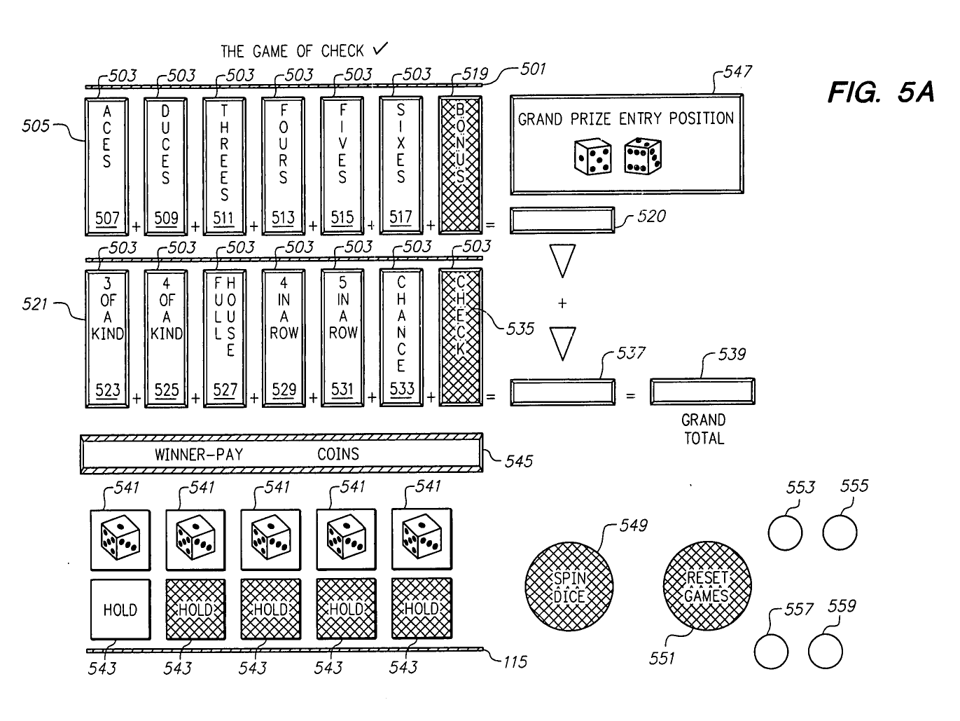

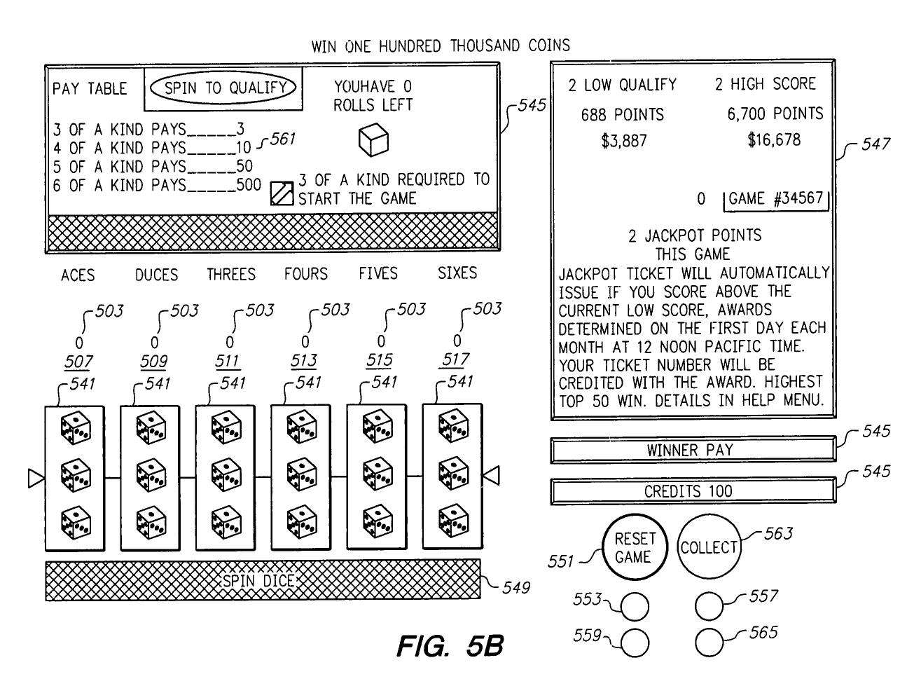

In a preferred embodiment of the present invention, the computer-controlled slot machine 101 includes a touch-sensitive display 115 for player input and game display. FIG. 5A illustrates the layout of the touch-sensitive display for use in playing one game. The touch-sensitive display 115 allows the player to make input selections conveniently, and displays game information in various ways, depending upon game state. The touch-sensitive display 115 allows the player to make input selections conveniently, and displays game information in various ways, depending upon game state. The upper left area of the display 115 displays a scorecard 501 which includes thirteen dual purpose score areas 503 pertaining to the thirteen possible scoring categories. These areas are utilized to accept a player's selection of a scoring category after achieving a scoring spin, and also to display the score achieved by a player in that category, as detailed below with respect to game play.

The computer-controlled display scorecard 501 is divided into two portions. The upper portion 505 of the scorecard 501 includes dual purpose score areas 503 of the display for Ones (or Aces) 507, Twos (or Deuces) 509, Threes 511, Fours 513, Fives 515, and Sixes 517. If the player exceeds a pre-determined score threshold on the upper portion 505 of the scorecard 501, the player is awarded a bonus score which is displayed in the bonus score display area 519 of the upper portion 505 of the scorecard 501. The upper portion 505 of the scorecard 501 also includes an upper portion score total display area 520 for displaying the total of all of the scores achieved in the scoring categories of the upper portion 505 of the scorecard 501. A detailed explanation of scoring is provided below with respect to game play.

The lower portion 521 of the display scorecard 501 includes dual purpose score areas 503 for 3-of-a-Kind 523, 4-of-a-Kind 525, Full House 527, a four-dice Straight 529, a five-dice Straight 531, the sum of all five dice (or Chance) 533, and 5-of-a-Kind (or Check) 535. The lower portion 521 of the scorecard 501 also includes a lower portion score total display area 537 for displaying the total of all of the scores achieved in the scoring categories of the lower portion 521 of the scorecard 501.

The display 115 includes a grand total score display area 539 which displays a player's grand total score as the sum of the upper portion score total and the lower portion score total.

The bottom left area of the display 115 includes five simulated dice 541. The bottom left area of the display 115 includes five hold buttons 543 immediately below the simulated dice 541. These hold buttons 543 are touch-sensitive areas, and are for holding a specific simulated dice 541 on a series of spins (rolls) when the player is attempting to obtain a certain combination, as detailed below with respect to game play.

The middle left area of the display 115 includes a text message box 545 for informing players of games states, such as number of spins remaining, winning combinations, game over, and for informing players of the amount of payouts.

The upper right area of the display 115 includes a message area 547 showing the position of the current scorecard 501 in the daily, weekly, monthly, or yearly prize jackpot award among multiple player networks for the prevailing scores. Alternatively, the message area 547 may show the top five scores on a multiple-player network that qualify for a jackpot, as well as the bottom five scores that so qualify, so that the player can see scores required to achieve a jackpot, as detailed below with respect to jackpots.

The bottom right area of the touch-sensitive display 115 includes a number of touch-sensitive areas which facilitate configuration and control of the game. Specifically, a touch-sensitive spin button 549 activates a spin (roll) of the simulated dice 541, a touch-sensitive reset button 551 resets the scorecard 501, and a touch-sensitive start game button 553 starts a game. A touch-sensitive wager button 555 allows a player to select the number of credits to wager, a touch-sensitive game mode selection button 557 allows a player to switch between game modes, and a touch-sensitive save-restore game button 559 allows a player to save or restore a game in progress to or from a card or voucher of machine-readable medium. Of course, the various buttons or control inputs, for example 543, 549, 551, 553, 555 and 557, described herein as touch-sensitive areas on the display, 115 may also be provided as mechanical electrical input devices, as desired.

FIG. 5B illustrates the layout of the touch-sensitive 115 display in accordance with an embodiment of the present invention for playing another game. The touch-sensitive display 115 allows the player to make input selections conveniently, and displays game information in various ways, depending upon game state. The upper left area of the display 115 displays a paytable 561 which indicates predetermined amounts to be paid for achieving specific scoring combinations. The paytable 561 is updated as the game progresses to reflect predetermined amounts to be paid for achieving scoring combinations at different stages of game play.

Below the paytable 561 are six score areas 503 of the display 115. There is a score area for Ones (or Aces) 507, for Twos (or Deuces) 509, for Threes 511, for Fours 513, for Fives 515, and for Sixes 517. Scoring combinations are assigned to appropriate score areas 503. A detailed explanation of scoring is provided below with respect to game play.

The bottom left area of the display 115 includes six simulated dice 541. In the embodiment shown in FIG. 5B, the simulated dice are in the form of a video simulated dice reels. Below the video simulated dice 541 is a touch sensitive spin button 549 that activates a spin (roll) of the simulated dice 541. In the embodiment illustrated in FIG. 5B, the spin button 549 is in the form of one spin bar common to all simulated dice 541 on the display 115.

The upper central area of the display 115 includes a text message box 545 for informing players of games states, such as number of spins remaining, winning combinations, game over, and for informing players of the amount of payouts. The upper right area of the display 115 includes a message area 547 showing the top score on a multiple-player network that qualifies for a jackpot, as well as the bottom score that so qualifies, so that the player can see scores required to achieve a jackpot, as detailed below with respect to jackpots. Alternatively, the message area 547 may show the position of the current score in the daily, weekly, monthly, or yearly prize jackpot award among multiple player networks for the prevailing scores.

In the embodiment illustrated in FIG. 5B, a text message box 545 for informing players of payout amounts, and a text message box 545 for informing players of the number of accumulated credits are located below the message area 547.

The bottom right area of the touch-sensitive display 115 includes a number of touch-sensitive areas which facilitate configuration and control of the game. A touch-sensitive reset button 551 resets the game, and a touch-sensitive start game button 553 starts a game. A touch-sensitive game mode selection button 557 allows a player to switch single and multiple-player game modes. A touch-sensitive save-restore game button 559 allows a player to save or restore a game in progress to or from a card or voucher of machine-readable medium. A touch-sensitive collect button 563 allows a player to collect accumulated winnings. In one embodiment, a touch-sensitive translate button 565 allows a player to select a language to be used for display output. Of course, the various buttons or control inputs, for example 551, 553, 557, and 559 described herein as touch-sensitive areas on the display 115, may also be provided as mechanical electrical input devices, as desired.

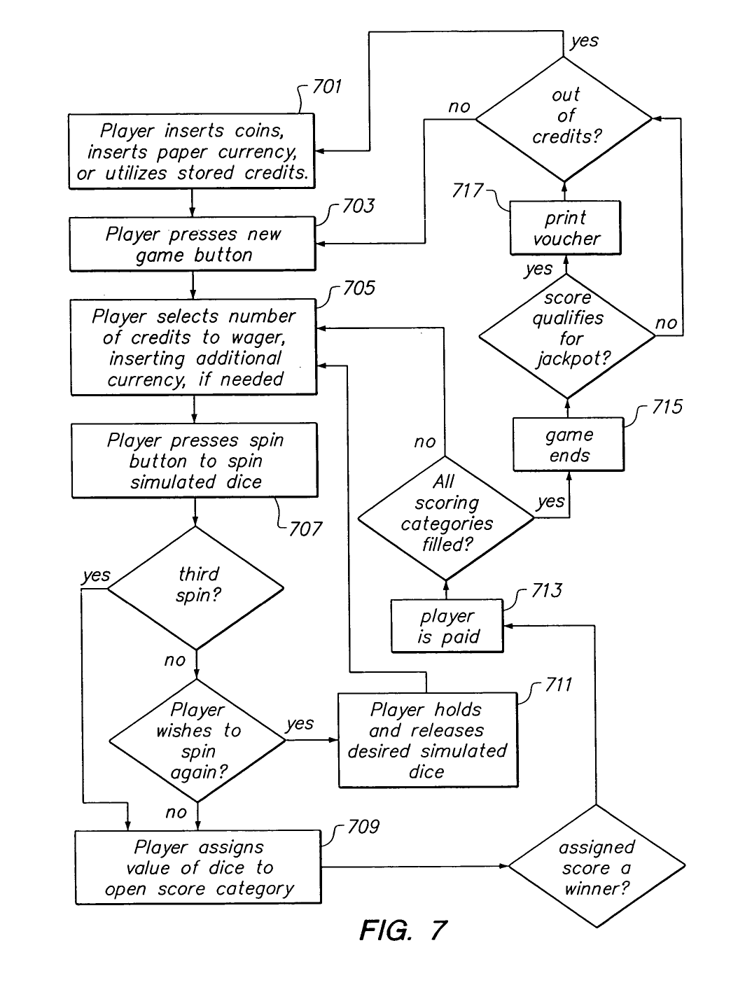

FIG. 7 is a flowchart, illustrating play of the game according to one embodiment of the present invention, which game may be implemented via the screen configuration illustrated in FIG. 5A. The object of the game is to ‘spin’ the simulated dice 541 for scoring combinations, and to get the highest total score accumulated within scoring categories of possible dice combinations. A player begins by inserting 701 one or more coins into the coin acceptor 111, by inserting 701 one or more bills into the bill validator 113, or by utilizing credits. The player then presses 703 the touch-sensitive start game button 553 to begin game play. The player then selects 705 the number of credits to wager on the spin of the simulated dice 541 by utilizing the touch-sensitive wager button 555 which controls the selection of the number of credits to be wagered. The player next spins 707 the simulated dice 541 by pressing the touch-sensitive spin button 549. The computer program 601 utilizes the random number generator 619 to produce random numbers that represent the results of the simulated roll of the simulated dice 541.

On each turn, the player may spin 707 the simulated dice 541 up to three times in order to get the highest scoring combination for a scoring category.

After each spin the player may assign 709 the value of the simulated dice 541 to one of the possible scoring categories by utilizing the dual purpose score areas 503 of the touch-sensitive display 115. If a player does so, the computer under program control senses the touched areas 503 and totals the value of the simulated dice 541 and calculates and displays the resulting score in the dual purpose score area 503 on the touch-sensitive display 115. The total score of the upper portion 505 of the scorecard 501 is displayed on the upper portion score total display area 520 on the touch-sensitive display 115. If the total score of the upper portion 505 of the scorecard 501 is 63 or higher, for example, then a bonus of 35 points, for example, is added to the upper portion score. This bonus is displayed on the bonus score display area 519 on the display 115. The total score of the lower portion 521 of the scorecard 501 is displayed on the lower portion score total display area 537 on the display 115. The grand total score is calculated by adding the upper portion and the lower portion scores together. The grand total score is displayed on the grand total score display area 539 on the display 115.

Each scoring category can only be scored or selected once during a game. Once a category is used, it cannot be reused until the next game either when the game is over because the scorecard 501 is complete or the player presses the touch-sensitive reset button 551. Pressing the touch-sensitive reset button 551 clears the entire scorecard 501 in preparation for the start of a new game.

Instead, if the player has not yet spun 707 three times during the present turn, the player may elect not to assign 709 the value of the simulated dice 541, but instead to spin 707 again. If the player elects to spin 707 again, the player may hold 711 one or more of the simulated dice 541 by pressing one or more of the associated hold button(s) 543. The player may also release 711 one or more of any held simulated dice 541 by again pressing the associated hold button(s) 543. The player may also elect not to hold or release 711 any of the simulated dice 541. The player then selects 705 the number of credits to wager on the spin of the simulated dice 541 by utilizing the touch-sensitive wager button 555. The player next spins 707 the simulated dice 541 by pressing the touch-sensitive spin button 549.

A turn is over after a player has spun 707 three times, or has assigned 709 the value of the simulated dice 541 to one of the possible scoring categories by utilizing the dual purpose score areas 503 of the touch-sensitive display 115. After a player has spun 707 three times, the player must assign 709 the value of the simulated dice 541 to one of the possible scoring categories by utilizing the dual purpose score areas 503 of the touch-sensitive display 115. If the score cannot be placed into one of the categories because it does not correspond or qualify, then the player must utilize the dual purpose score areas 503 of the touch-sensitive display to assign 709 a zero to one of the remaining categories.

If the player has achieved a scoring combination and assigns 709 it to one of the scoring categories, the player is paid 713 via the coin hopper 123. Alternatively, the player may elect to receive credits. The computer program 601 calculates payment according to a paytable, which is based upon points scored per turn, and the number of spins needed to achieve the points.

If the player assigns 709 a zero score to one of the categories, the player is not paid. Alternative embodiments may employ different paytables, as desired.

The player may then proceed with the next turn and continue filling the scorecard 501. To proceed with the next turn, the player utilizes the touch-sensitive wager button 555 to select 705 the number of credits to be wagered on the spin of the simulated dice. The player next spins 707 the simulated dice 541 by pressing the touch-sensitive spin button 549 and plays a turn, as described above. The game ends 715 when the player has filled all thirteen categories with a score or a zero or is out of credits to play the computer-controlled slot machine 101.

Once the game has ended, the computer program 601 evaluates the player's scorecard 501 against other current scores to determine if a progressive jackpot will be awarded on a daily, weekly, monthly, or yearly basis. If the player has a currently qualifying scorecard 501, the computer-controlled slot machine 101 prints 717 a voucher for the player with a control number and other pertinent information for later redemption, if the scorecard 501 is a winner.

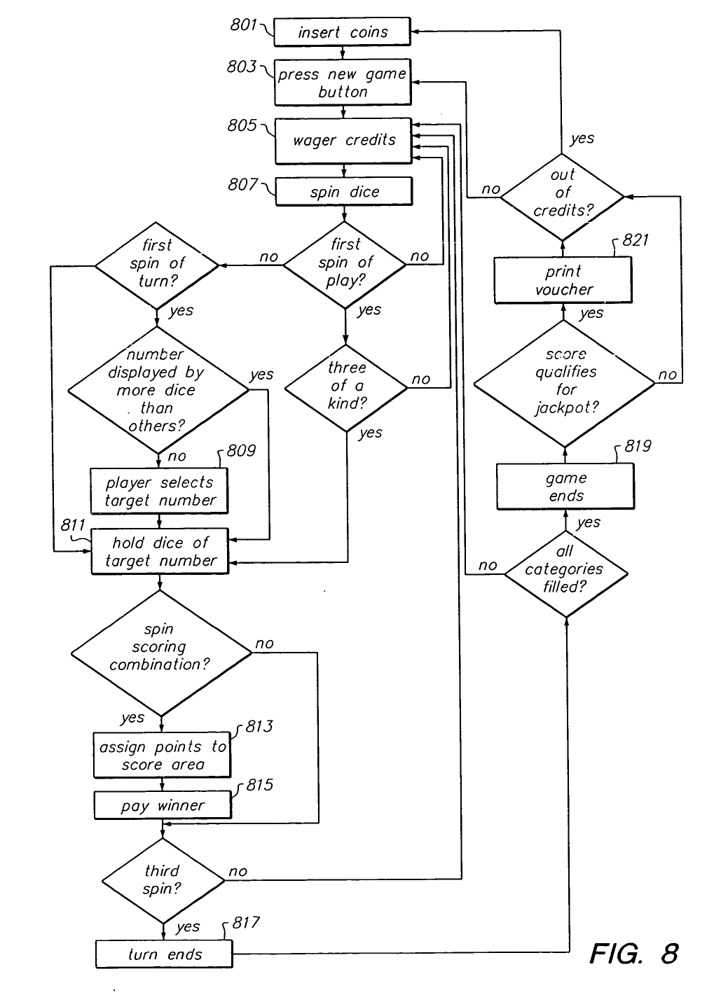

FIG. 8 is a flowchart illustrating play of another game according to one embodiment of the present invention, which game may be played using the screen configuration illustrated in FIG. 5B. The object of the game is to ‘spin’ the simulated dice 541 for scoring combinations, and to get the highest total score accumulated within scoring categories of possible dice combinations. A player begins by inserting 801 one or more coins into the coin acceptor 111, by inserting 801 one or more bills into the bill validator 113, or by utilizing credits. The player then presses 803 the touch-sensitive start game button 553 to begin game play. In one embodiment, three credits are automatically wagered 805 on each spin of the simulated dice 541. In another embodiment, the player selects the number of credits to wager on the spin of the simulated dice 541 by utilizing the touch-sensitive wager button 555 which controls the selection of the number of credits to be wagered. The player next spins 807 the simulated dice 541 by pressing the touch-sensitive spin button 549. The computer program 601 utilizes the random number generator 619 to produce random numbers that represent the results of the simulated roll of the simulated dice 541.

The player must achieve at least three of a kind on a single spin to begin play of an individual game. Until a spin generates at least three simulated dice 541 displaying identical numbers, the player must continue spinning 807 to attempt to generate the minimum achievement required for game entry. A wager is required for each spin of the simulated dice 541. Once a spin generates at least three simulated dice 541 displaying identical numbers, those simulated dice 541 are automatically held 811, and a predetermined number of points is automatically assigned 813 to the appropriate scoring area 503. The number of points awarded is displayed in the appropriate score area 503, which preferably changes color to indicate active status. The spin that generated the requisite achievement is counted as the first spin of a turn, and the scoring number becomes a target number for the remainder of the turn. A target number is a number that the player can receive points for generating during a given turn.

For example, if a first spin results in four aces (ones), the predetermined number of points for achieving four of a kind on the first spin of a first turn is automatically assigned 813 to the scoring area 503 for aces 507. Aces becomes the target number for the remainder of the turn. Thus, on the subsequent spins of the turn, the player will receive additional points only for generating aces.

The requirement of generating at least three of a kind applies only to the first turn. A player must achieve three of a kind to enter the game and begin the first turn. Once a player has generated the requisite achievement and entered the game, subsequent turns do not require a minimum achievement to begin.

On each turn, the player may spin 807 the simulated dice 541 up to three times in order to get the highest scoring combination for a scoring categories.

After the first spin of a turn, the number displayed by the largest plurality of the video simulated dice 541 automatically becomes the target number for the current turn. The simulated dice 541 of the target number are automatically held 811, and the score area 503 for the target number preferably changes color to indicate that it is the active score area 503 for the turn. If at least three dice 541 displaying the target number have been generated, a predetermined number of points is assigned 813 to the score area 503 for the target number.

If the first spin does not result in a largest plurality of dice 541 displaying any one number, the player selects 809 a target number from amongst those displayed by an equal number of the simulated dice 541. For example, if the first spin results in two aces, two deuces, one four and one five, the player may select 809 acres or deuces as the target number. The selection is made by touching the desired score area 503 of the touch-sensitive display 115. Preferably, the score areas 503 which the player may touch to choose a target number blink or change color or size or otherwise provide visual indication of the choices available.

If the player has not yet spun 807 three times during the present turn, the player may spin 807 again. The player next spins 807 the simulated dice 541 by pressing the touch-sensitive spin button 549. During the second and third spins of a turn, any generated dice 541 displaying the target number are held 811. Preselected numbers of points are assigned 813 to the appropriate scoring area 503 for scoring three, four, five, or six of the target number.

After each spin, if the player has achieved a scoring combination, the player is paid 815 via the coin hopper 123. Alternatively, the player may elect to receive credits. The number of predetermined points awarded for various scoring achievements is displayed in a paytable 545 on the display 115. The paytable 545 is adjusted as the game progress, reflecting predetermined numbers of points to be paid for various achievements at a particular stage of the game. For example, more points are awarded for achieving a six of a kind on a first spin than on a third spin. Amounts to be paid are based upon the odds of achieving various scoring combinations at a given stage of game play, taking into account number of unheld dice to be spun, and numbers removed from possible generation.

Alternative embodiments may employ different paytables 545, as desired.

A turn ends 817 after a player has spun 807 three times, or achieved six of the target number prior to the third spin.

Each scoring category can only be scored or selected once during a game. Once a category is used, it cannot be reused until the next game either when the game is over because a score has been assigned to each category, or the player presses the touch-sensitive reset button 551. Pressing the touch-sensitive reset button 551 terminates the current game and starts a new game. Once a scoring category for a given number has been used, that number is replaced for the remainder of the game by a non-numerical symbol, for example the letter “Z” or a graphic symbol of a piece of fruit, be made blank or darkened, or as desired. During subsequent turns, when the random number generator 619 generates the used number, the non-numerical symbol is displayed instead.

After completing a turn, the player may then proceed with the next turn and continue filling the score areas 503. To proceed with the next turn, the player next spins 707 the simulated dice 541 by pressing the touch-sensitive spin button 549 and plays a turn, as described above.

The game ends 819 when the player has filled all six score areas 503 with a score, or is out of credits to play the computer-controlled slot machine 101.

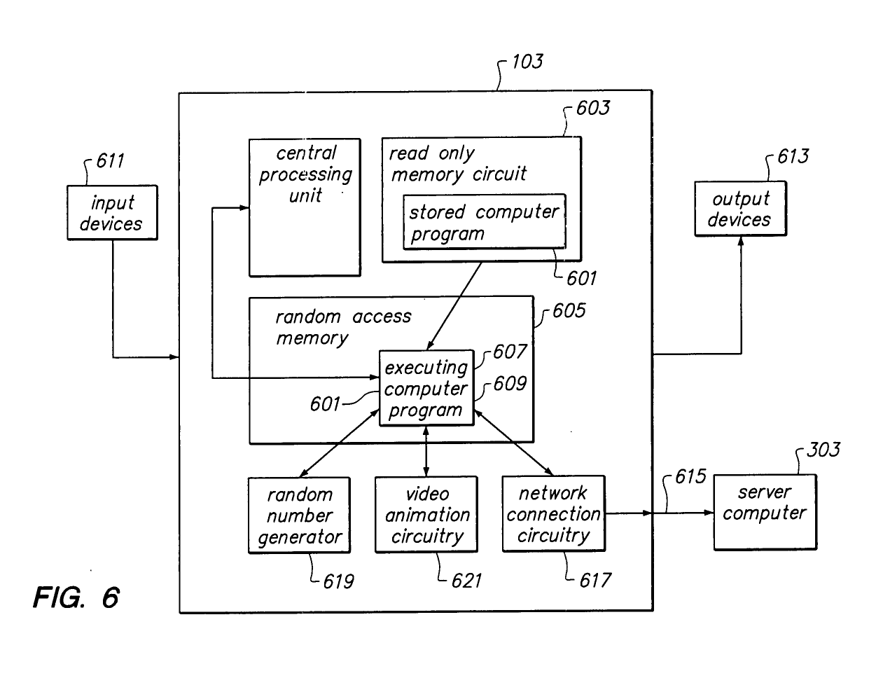

FIG. 6 illustrates an embodiment of a computer system that facilities game play. In one embodiment, game play is facilitated by a computer program 601 executing in the microprocessor-controlled computer 103 within the computer-controlled slot machine 101. In the preferred embodiment of the present invention, the computer program is stored on a read-only memory integrated circuit 603 that is operatively coupled to the microprocessor-controlled computer 103 in the computer-controlled slot machine 101. Of course, in alternative embodiments, the computer program may be stored on various other storage media, such as semiconductor memory or optical or magnetic disk, or the like.

The computer program 601 executes from the random access memory 605 of the microprocessor-controlled computer 103 in the computer-controlled slot machine 101, and includes code 607 and data 609 to facilitate the play of the game of Check in accordance with the game rules, as detailed below with respect to game play.

The computer program accepts user input from various user input devices 611 of the types previously described, including coin acceptor 111, bill validator 113, the touch-sensitive display 115, and the machine-readable medium reading and writing device 129. Other input devices including mechanical button type switches and lever-arm switch actuators may be used in alternative embodiments as desired.

The computer program also controls computer operation of the various output devices 613 such as the display 115, the sound speaker 117, a tower light 119, the meter 121, the coin hopper 123, the ticket printer 125, and the machine-readable medium reading and writing device 129.

Preferably, the computer program 601 also controls communication with the microprocessor-controlled server computer 303 which controls the local area computer network 301. The computer program 601 controls this communication via a network port 615 and network connectivity circuitry 617 contained within the microprocessor-controlled computer 103.

The computer program 601 utilizes a random number generator 619 to produce random numbers that represent the results of the simulated rolling of the simulated dice 541. The computer program 601 utilizes animation circuitry 621 to produce the simulation of dice on the display 115.

In one embodiment, utilizing a local area computer network 301 and a wide area computer network 401, multiple players may play the games against one another instead of “against the house.” Utilizing a local area computer network 301, each participating player deposits money into an individual computer-controlled slot machine 101 for each spin. The player who achieves a highest score (or other winning criteria) of all of the players who are participating in that multiple player game on the local area computer network 301 wins the money deposited by the various participating players (typically, minus a percentage for the house). The same methodology can be utilized across a wide area computer network 401, allowing players at different physical locations to compete against each other in real time.

In various games, a player may attempt to obtain a high total score for qualifying for a jackpot. In one or more embodiments, the jackpot comprises a percentage of the monies wagered by the players of the game(s). In this manner, the jackpot continues to increase over time with play, and over time, may comprise multi-million dollars in size. The jackpot may comprise monies belonging to the establishment offering the game, and may comprise other than cash prizes. In one or more embodiments, jackpot prizes are awarded at various intervals. The interval may be daily, weekly, monthly, yearly, or the like. The intervals may vary or be evenly spaced.

In a preferred embodiment, jackpot prizes are awarded to one or more players in a pool who have achieved a high score playing the game. In one embodiment, a set number of players, such as twenty, who have achieved the highest scores playing the game during a jackpot interval may participate in the jackpot. For example, the jackpot may be awarded on the 1^{st} of each month, with the players who have achieved the twenty highest scores during the previous month participating in the jackpot. Of course, a gaming establishment may determine the total number of participants.

The participation by the players in the jackpot may be even (i.e. divide the jackpot by the number of participating players) or may be on a sliding or other scale where the higher the player's ranking, the greater that player's participation in the jackpot. The jackpot may also be a fixed amount for each player, or be fixed based on their ranking.

Of course, the manner by which a player is determined to be entitled to participate in the jackpot may vary. For example, players having the lowest scores may be entitled to participate.

In an embodiment where each player plays a slot machine 101, the player preferably places a wager or bet directly on or in association with the game to be played. For example, the player may place a wager of $1.00 to play the game. The games of the invention, including the multi-player games, may be played on other than a slot or dedicated gaming machine. For example, the games may be presented in a networked environment using wireless devices such as cellular phones or personal data assistants (PDAs). Game data may be transmitted to and from these devices and a game server or other device or system in similar manner to the network 301 described above.

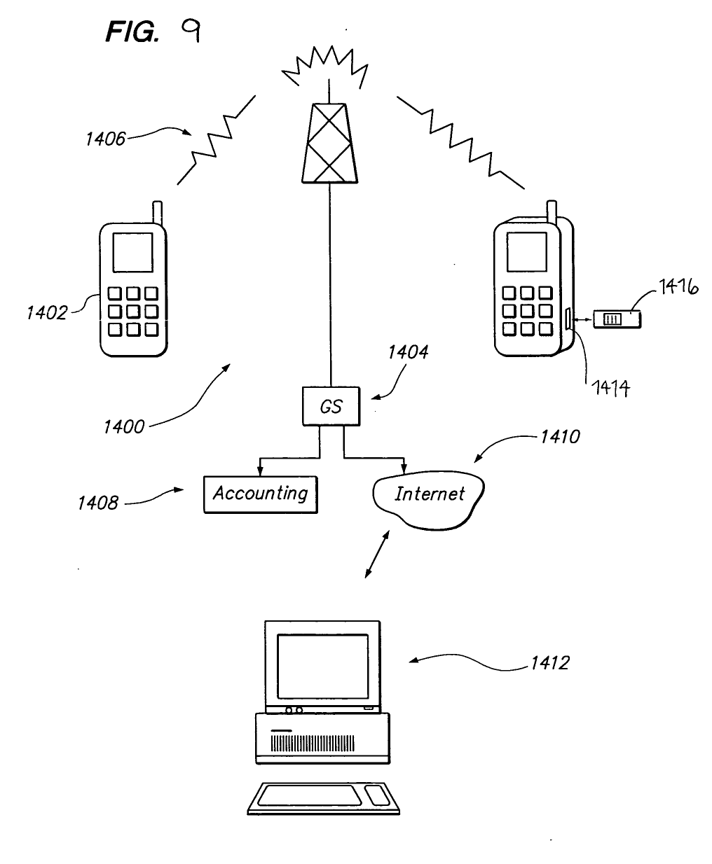

Another embodiment of a gaming system and gaming devices is illustrated in FIG. 9. As illustrated therein, the gaming network 1400 includes a variety of wireless devices 1402. These devices may comprise cellular phones, PDAs or the like. Each device 1402 is capable of communicating with a game server 1404 via a communication link 1406, at least a portion of which is wireless. As illustrated, in one embodiment, the game server 1404 is configured to generate and transmit game data to the wireless devices 1402. In one embodiment, a player may establish entitlement to play a game by paying for communication access to the game server 1404, such as by paying for air or connect time.

As illustrated, the game server 1404 may be in communication at one or more times with an accounting server 1408 or system. This system may track game play win and loss amounts, make credits of air time in the form of wagers or the like, as described below.

In one embodiment, the game server 1404 may also be in communication with other devices. As illustrated, a user may access the game server 1404 from a workstation 1412, such as a kiosk or home computer. Access may be provided via the Internet 1410 or other communication link.

As one aspect of the invention, bets or wagers, or the “value” otherwise required in order for the player to play the game for the opportunity to be paid winnings or be awarded an award, may be placed indirectly. For example, in the embodiment illustrated in FIG. 9, a player's wager may be associated with or comprise air or connect time. For example, a player may pay a certain monetary amount per minute in order to utilize their cellular phone or PDA or utilize a communication link established with their device. All or a portion of that amount may be attributed to a jackpot amount. In another embodiment, the player may pay an additional amount, such as a surcharge, to play the game and that surcharge or a portion thereof may be applied to the jackpot.

Referring to the embodiment system 1400 illustrated in FIG. 9, a player may pay for air or connect time through a wireless communication provider. The wireless communication provider may provide a communication link to the game server 1404. Players who access the game server 1404, such as by calling a telephone number associated with a communication link to the game server, maybe charged an access surcharge. The access time and corresponding surcharge may be tracked by the accounting server. The surcharge amounts may be transmitted to the wireless communication provider for inclusion on the customer's bill. All or part of the surcharge amounts may be applied by the accounting server 1408 to the jackpot. The surcharge or fee may be calculated in a variety of manners. In one embodiment, the fee is based upon the time the player is connected to the game server via the communication link, from when the communication link is established to when it is terminated, similar to a cellular telephone call. In other embodiments, the fee or surcharge may only be applied during the time the player is actually playing the game.

It is noted that this arrangement may be applied to other gaming environments. For example, in one embodiment of the invention a player may access a game server from a home computer or the like via a wired or wireless communication link. The player may be charged a fee for this access time in a similar manner to that described above.

In one embodiment of the invention, game code may be provided to the devices 1402 to enable presentation and play of the game. In one embodiment, as illustrated in FIG. 9, the device includes a media reader 1414 for reading a media 1416. The configuration of the media reader 1414 may depend substantially upon the type of media to be read. For example, the media 1416 may comprise a smart card, magnetic strip card or the like, in which case the media reader 1414 may comprise a device for reading such a media.

Preferably, the media 1416 contains game program code for use by the device 1402 in presenting a game. The game program code may comprise executable code, or may comprise data. The data may comprise graphic images or the like.

In one embodiment, a user of the device 1402 may obtain a media 1416 containing the game program code. For example, the user may purchase the media 1416 from an authorized content provider or distributor. The user may then use the reader 1414 to read the media 1416 to provide the code to their device 1402.

In this configuration, the game server 1404 may send instructions to the device 1402 causing the device to execute the game program code or to otherwise use the game program code data to present a game to the user. This configuration has the advantage that a lesser amount of data must be transmitted from the game server 1404 to the user's device 1402 in order to present a game.

In one embodiment, a user may purchase or obtain one media 1416 having game program code associated therewith pertaining to a plurality of games. In another embodiment, each media 1416 may only have one game associated therewith, as in a “cartridge” type format.

In one embodiment, the game program code may be loaded to a memory of the device 1402, such as in the case of a PDA. In another embodiment, the code may remain stored on and be read from the media 1416, such as in the case of a cell phone having limited memory.

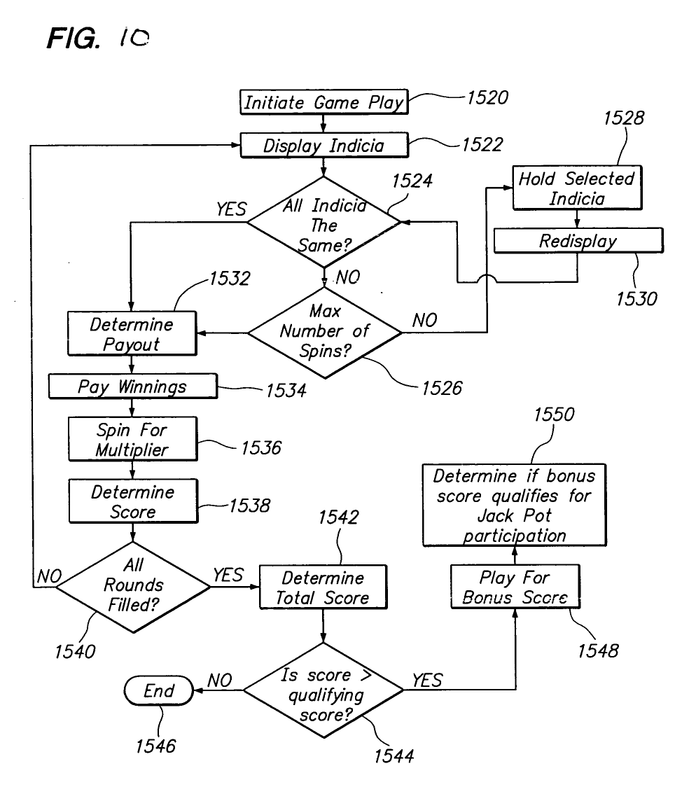

As described above, the game of the invention may be played with numerous variations. Another embodiment of a game of the invention will be described with reference to FIG. 10. This game has particular applicability to a system 1400 such as that illustrated in FIG. 9. In particular, this game is suited to generation of game data by execution of a gaming application at the game server 1404 and then transmission of game data to the devices 1402 for display. In addition, the game may be funded using air time or similar charges.

In a step 1520, game play is initiated. The game starts by play of a base or individual game. This step may comprise, for example, the player using their wireless device to access the game server.

In one embodiment, the game is a multi-round game in which a player plays for a score. In a step 1522, game indicia are displayed to the player for use in a first round of play. The indicia may be generated at the game server and then corresponding display data may be transmitted to player's device for display. In one embodiment, the indicia comprise images of the sides of dice.

In a step 1524, it is determined if all of the indicia are the same. If so, then in a step 1532, a payout is determined. This step will be described in more detail below.

If in step 1524 all the indicia are not the same, then in a step 1526, it is determined if the player has already used the maximum number of spins. If so, then the payout it determined in step 1532. If not, then in a step 1528, the player is permitted to hold selected indicia. This may be accomplished using buttons, a touch-screen, stylus or other means. The player may hold none, one or more of the indicia. In a step 1530, the indicia which are not held are spun or re-displayed. This may comprise the game server randomly generating new indicia for replacement of the non-held indicia.

In one embodiment, the player may be permitted to hold and replace indicia two times. In other embodiments, the player may be not be permitted to hold and replace indicia at all, or may be permitted to do so other numbers of times. Once the player has exhausted their spins or they have received all of the same indicia, then in step 1532 a payout is determined. In one embodiment, the payout is determined based upon the combination of indicia which the player received. Preferably, higher payouts are provided for greater numbers of matching indicia. The payouts may be dependent upon the number of points the sum of the “pips” of the matching dice, or may be independent therefrom (such as based solely upon the particular combination received). In one embodiment, the payout is based upon the greatest number of matching indicia. In the event there are two or more sets of the same number of matching indicia, then the indicia having the largest value (i.e. 6>5) may be selected.

In a step 1534, winnings are paid. Winnings may be paid in the form of credits or otherwise.

In a step 1536, a multiplier is generated. In one embodiment, a multiplier is generated by “spinning” or otherwise displaying two dice. The outcome of the spin is summed, that sum comprising the multiplier. For example, if the player receives a 4 and a 3, then the multiplier is 12. The multiplier may be generated in other ways, such as by random selection of a number, player selection of hidden dice from a set of dice or the like.

In a step 1538, a score for the round is determined. In one embodiment, the score comprises the sum of the pips or points of the greatest number of matching dice, multiplied by the multiplier. For example, if the player has received four 6s and a multiplier of 12, the total point score is 4×6×12=288.

In a step 1540 it is determined if all of the rounds have been completed. In one embodiment, the game comprises a maximum of six rounds. If all rounds have not been completed, then the game returns to step 1522 with another set of indicia being displayed. If all rounds have been completed, then in a step 1542 a total game score is determined. In one embodiment, this score comprises the sum of the scores for each round.

In a step 1544 it is determined if the game score is greater than a qualifying score. If not, then the game ends in step 1546. If so, then in a step 1548, the game is played again in the form of a bonus game in which a player plays for a bonus score 1548. Preferably, the play of the game for the bonus score is the same as that described above. Preferably, the player plays for a bonus score which entitles them to a jackpot amount in similar fashion to that described above. For example, the player attempts to receive a score, such as the highest score, for all bonus games played during a period of time. At the end of the predetermined period of time, in a step 1550 is determined if the player has won or has qualified to participate in, the jackpot. If so, the player is awarded a jackpot winning, such as a very large monetary award.

Preferably, the qualifying score is set sufficiently low that it is frequently attained, and thus entices the player to play the game in an attempt to play the bonus game. Round results, round scores, multipliers and the like are preferably displayed to the player, such as via a game board. Data representing the game board may be generated by the game server and transmitted to the player's device for generating the display.

Variations of the method of game play are contemplated. For example, when implementing the game with a system 1400 such as illustrated in FIG. 9, steps 1532 and 1534 may be eliminated. Instead, the player may play the game for a score only, attempting to reach the bonus round. If the player reaches the bonus round, the player may then be entitled to win the jackpot. In this embodiment, much higher jackpots may be awarded because no “intermediate” winnings are awarded for play of the main game. This also simplifies the game play, eliminating the need to pay remote players for round winnings. If a player wins the jackpot, the player may be paid via their wireless communication account or by using information associated with that account to identify the player to the game provider.

Use of a multiplier is preferred, but not required. The multiplier, as disclosed, has the benefit of creating a much larger score distribution, allowing for higher scores and more excitement.

Various numbers of indicia may be displayed per round, such as five or six dice indicia. In addition, a particular indicia has been used, that indicia may become inactive for the remainder of the game. As described herein, that indicia may be removed from play, may be darkened or the like to indicated that it is inactive. When indicia are removed from play, as described above, the payouts associated with remaining combinations may increase, reflecting the reduced odds of receiving combinations of indicia.

It is contemplated that various features of the game just described may be applied to other games. For example, a multiplier may be used in association with the generation of the scores of the other embodiment games of the invention. The bonus or jackpot feature may also be applied to other games. For example, the jackpot feature may be applied to the well known game of video poker. In one embodiment, individual players play one or more games of video poker for a score, such as points or credits. In one embodiment, the players play multiple games, each game comprising a “round.” The score achieved by the player as a result of their game play (such as the score for a single game or the aggregate of all rounds) is compared to a threshold. If the player qualifies, the player is permitted to play one or more of the games for a bonus score.

This aspect of the game may be applied to other games, such as Blackjack. These games may be modified so that points are awarded as well as credits or winnings for each individual game. Further, hands may be differentiated so that differing numbers of points are attainable. For example, in the game of video poker, 50 points may be awarded for a flush of Hearts, while only 45 points awarded for a flush of Diamonds. In this manner, a greater distribution of points can be provided. In addition, a multiplier or similar feature may also be utilized to generate the score for each game or round, again contributing to a wider range of scores for the games, and thus making qualifying more interesting.

As one aspect of the invention, a player who qualifies is preferably permitted to play the game or games in the bonus round without placing an additional wager. This feature further entices players to play the base or main game to qualify, since once they qualify, it costs the player nothing to play the bonus game for a chance at winning the bonus or jackpot.

As one aspect of the invention, a player may be permitted to play their bonus game or games for their bonus score at any time. For example, a player may desire to wait and play their bonus game close to the time the bonus interval is over, as at that time they may feel they have a better chance of winning.

In one embodiment, a player may track whether or not they are in the running to win the jackpot during a given payout interval. For example, the highest score or scores may be made available to the player, such as by being posted to the player's device, via a website or the like. The player may compare their score(s) against these scores to determine if they are still entitled to participate in the jackpot. A player may determine that their score is no longer high enough to qualify for jackpot participation (such as by reason of a number of later players receiving higher scores and displacing the player from the top twenty highest scores). In such event, a player may play one or more games before the award of the next jackpot.

In one embodiment, each game score is associated with a game number. The highest (or otherwise qualifying game scores) may be posted with the game numbers. In one embodiment, game results may be printed on a player voucher. The player may then redeem the voucher for their jackpot award at a gaming establishment or other location.

Alternatively, achieving a predetermined score may be utilized for awarding a predetermined jackpot. For instance, if a player achieves a perfect score, meaning the theoretically highest score for each category, then a jackpot may be awarded for such achievement.

It will be appreciated that the predetermined winning combinations and their payouts may vary from those described and illustrated herein. For example, instead of attempting to achieve matching indicia, a player may be directed to achieve a full house, a straight or other combinations. In one or more embodiments, especially when bonuses or jackpots are not awarded, winning combinations may include the more commonly obtained 2 pair or even a single pair. It will be appreciated that when a portion of the wager is diverted to the generation of bonus and jackpot payouts, paying on such commonly occurring combinations is less desirable, as the hold for the game may be minimal or non-existent to the house.

As used herein, the term “computer-controlled slot machine” denotes a computer controlled machine which preferably facilitates wagering. As disclosed above, such a wager may be placed directly or indirectly. It will be appreciated that one or more aspects of the machine, including the interface or what is referred to herein as the touch sensitive display may be electrical, mechanical and/or electro-mechanical in nature. For example, while the buttons may comprise touch-sensitive areas of a display, they may comprise electro-mechanical buttons which are activated by mechanical movement (such as depression) by a player. In addition, the simulated dice may, instead of comprising solely computer generated images, actually comprise dice or dice faces mounted on a rotating reel and arranged to stop in controlled positions. The simulated dice or other symbols may be provided in a variety of other manners, such as by laser light generation. The dice or other symbols are referred to in certain instances as “simulated,” but could actually comprise faces of actual physical dice. The displays and display areas may comprise CRT type displays, LCD or LED displays or any other means for displaying information now known or later developed.

It will be appreciated that various features of the present invention may be applied to existing games or games later developed. It will also be appreciated that various games other than those described herein may be played on as implemented via the gaming systems and the devices of the invention.

It will be understood that the above described arrangements of apparatus and the method therefrom are merely illustrative of applications of the principles of this invention and many other embodiments and modifications may be made without departing from the spirit and scope of the invention as defined in the claims.

I claim:

1. A gaming system comprising:
at least one gaming machine in a first territory;
a game server located in a second territory remote from said first territory, said game server configured to transmit game data to said at least one game server and accept game data from said at least one gaming machine;
a first transmitter/receiver located in said first territory;
at least one first communication link between said first transmitter/receiver and said at least one gaming machine;
a second transmitter/receiver located in said second territory;
at least one second communication link between said second transmitter/receiver and said gaming server; and
at least one communication link between said first transmitter/receiver and said second transmitter/receiver, said communication link comprising a satellite communication link via one or more space-borne satellites, whereby game data is exchanged between said game server and said at least one gaming machine via said communication link without using communication equipment in any other territory other than first and second territory or said one or more space-borne satellites.

2. The gaming system in accordance with claim 1 wherein a plurality of first gaming machines are associated with a first network in said first territory and said first transmitter/receiver is in communication with said first network.

3. The gaming system in accordance with claim 2 including a plurality of second gaming machines associated with a second network in said second territory and wherein said second transmitter/receiver is in communication with said second network.

4. The gaming system in accordance with claim 1 wherein said first territory comprises a first sovereign Indian land and said second territory comprises a second sovereign Indian land.

5. The gaming system in accordance with claim 1 wherein said first territory comprises a first U.S. State and said second territory comprises a second U.S. State.

6. The gaming system in accordance with claim 5 wherein at least one third U.S. State is located between said first and second U.S. States.
